(19) United States
(12) Patent Application Publication
(10) Pub. No.: US 2020/0103836 A1
(43) Pub. Date: Apr. 2, 2020

(54) GENERATING ACTIONABLE PLANT TASKS FROM TWO OR MORE OPERATIONAL DATA SOURCES

(71) Applicant: HONEYWELL INTERNATIONAL INC., Morris Plains, NJ (US)

(72) Inventors: Graeme Laycock, Hunters Hill (AU); Mark Bertinetti, East Killara (AU); Rahul Nath, Redfern (AU); David Granatelli, Lilyfield (AU)

(21) Appl. No.: 16/577,516

(22) Filed: Sep. 20, 2019

Related U.S. Application Data
(60) Provisional application No. 62/738,817, filed on Sep. 28, 2018.

(51) Int. Cl. G05B 13/04; G05B 13/02

(52) U.S. Cl. CPC G05B 13/042; G05B 13/0265; G05B 13/048

(57) ABSTRACT

A system for generating actionable plant tasks from multiple operational data sources includes a computing device including an associated memory configured for receiving operational data associated with the plant from ≥2 devices in the plant, where the operational data includes one or more alerts associated with problem(s) that have occurred at the plant. At least one numerical confidence value relating to a reliability is assigned to each operational data, at least one numerical importance value relating to importance is assigned to an operation of the plant to each operational data. The operational data is analyzed to determine correlations between different portions of the operational data, and based on the confidence values and the importance values at least one task associated with resolving the problem is determined, an action associated with the task is determined, and then an indication relating to the action is transmitted to another computing device.

### CROSS REFERENCE TO RELATED APPLICATIONS

This application claims the benefit of Provisional Application Ser. No. 62/738,817 entitled “PRODUCTION OPTIMIZATION AND ANALYSIS,” filed Sep. 28, 2018, which is herein incorporated by reference in its entirety.

### FIELD

This Disclosure relates to managing the operation of a plant, such as a chemical plant or a petrochemical plant or a refinery, and more particularly to managing plant operations.

### BACKGROUND

A plant or refinery may, in the process of producing a product such as a product gas, be configured to monitor operational data corresponding to the operation of the plant. For example, a control system of a plant or refinery may monitor one or more sensed process parameters.

The operational data may indicate that the plant is operating sub-optimally. For example, cybersecurity information may suggest that one or more computing devices at the plant do not have required cybersecurity software upgrades and are therefore potentially vulnerable to data exfiltration. As another example, a pipe carrying fuel for a burner may be clogged, reducing the flow rate of fuel to a burner and as a result reduce the heat produced by the burner. As yet another example, control systems may be undesirably constrained and/or configured to generate an undesirable quantity of alarms, suggesting problems associated with one or more process variables used by the control system(s). Such information may comprise warnings or alarms, for example an alarm that a particular portion of a plant is generating smoke or is on fire.

### SUMMARY

The following Summary presents a simplified summary of certain features. This Summary is not an extensive overview and is not intended to identify key or critical elements.

Disclosed aspects recognize a particular problem for plants where the volume, speed, and complexity of plant operational data may make it difficult to collect, synthesize, and act upon the operational data which may include warnings or alarms. While individual warnings or alarms (e.g., a pipe being clogged) may be detected by a sensor and acted upon by control system, interrelations between different warnings or alarms may be difficult to identify and remedy. For example, a worker may be tardy and fail to perform an early morning maintenance task, causing excessive vibration in a plant asset such as a particular piece of processing equipment, which may impact the efficiency of production of the product produced by the plant, thereby ultimately causing a plant to perform sub-optimally. The presence of multiple warnings or alarms may suggest a common fault or common problem that may not be obvious if each warning or alarm is remedied individually. In some cases, individual remediation of alarms or warnings may make problems associated with other alarms or warnings worse.

Disclosed aspects solve the above-described problem by providing a disclosed analysis engine for collecting plant operational data, analyzing the plant operational data, determining tasks based on the analysis, and implementing such tasks (e.g., adjusting settings for plant processing equipment in order to improve the operating parameters). A computing device implementing a disclosed analysis engine receives, from two or more devices at a plant, operational data. The operational data may comprise one or more alarms or warnings. The operational data may comprise information regarding plant profit and/or loss, equipment, chemical processes, workforce performance, automation system performance, safety system performance, and/or cybersecurity performance.

Such operational data may comprise operational details of the production process, such as a health of a catalyst for a chemical process or a flow rate of fuel to a burner. The operational data may comprise information associated with processing equipment in the plant, such as a flow rate of fuel to a burner, whether a pump is malfunctioning, or the like. The operational data may comprise a profitability of the plant or refinery, such as a dollar value associated with current costs and output of the plant or refinery. The operational data may comprise workforce information, such as the availability or activity of employees. Other operational data may relate to the performance of an automation system controlling production at the plant, the performance of safety systems and processes, and/or the state and performance of cybersecurity aspects of production.

The analysis engine may analyze the operational data to determine, e.g., one or more correlations. For example, the analysis engine may determine a root cause associated with the operational data. The analysis engine may determine, for all or portions of the operational data, a confidence level and/or an importance level. The analysis engine may determine, based on the operational data, one or more tasks. The tasks may be configured to improve all or portions of the operational data, such as being remediating actions responsive to one or more alarms or other warnings. The tasks may involve replacement and/or shutdown of all or portions of the plant. The analysis engine may be configured to transmit, to another computing device, an indication of the task. For example, the analysis engine may transmit an instruction associated with a task to a mobile device of a plant engineer, and/or may transmit instructions to a plant control device and cause the plant control device to perform an action corresponding to a task, where the plant control device may automatically adjust a flow rate, pressure, temperature, a valve, or the like.

Disclosed aspects include a system for generating actionable plant tasks from multiple operational data sources includes a computing device having an associated memory configured for receiving operational data associated with the plant from ≥2 devices in the plant, where the operational data includes one or more alerts associated with problem(s) that have occurred in the plant or problems that are currently occurring in the plant. At least one numerical confidence value relating to a reliability is assigned to each of the operational data, and at least one numerical importance value relating to importance is assigned to an operation of the plant to each of the operational data. The operational data is analyzed to determine correlations between different portions of the operational data, and based on the confidence values and the importance values at least one task associated with resolving the problem is determined. An action associated with the task is determined, and then an indication relating to the action is transmitted to another computing device.

### BRIEF DESCRIPTION OF DRAWINGS

The present disclosure is illustrated by way of example and not limited in the accompanying figures in which like reference numerals indicate similar elements and in which:

FIG. 1A shows an example system for implementing a catalytic dehydrogenation process, in accordance with one or more example embodiments.

FIG. 1B shows an example system for implementing a fluid catalytic cracking process in accordance with one or more example embodiments.

FIG. 2 depicts an example system for implementing a catalytic reforming process using a (vertically-oriented) combined feed-effluent (CFE) exchanger in accordance with one or more example embodiments.

FIG. 3 depicts an example system for implementing a catalytic dehydrogenation process (e.g., OLEFLEX) with continuous catalyst regeneration (CCR) using a (vertically-oriented) hot combined feed-effluent (HCFE) exchanger in accordance with one or more example embodiments.

FIG. 4A shows an example network diagram of a system comprising a programmed computer implementing an analysis engine.

FIG. 4B shows an example plant with various operational data collecting devices.

FIG. 5 is a flow chart of a method for establishing actionable plant recommendations from operational data received from two or more devices that may be performed by a computing device implementing a disclosed analysis engine.

FIG. 6 shows an example data flow using a disclosed analysis engine.

FIG. 7 is a diagram showing an illustrative example of a disclosed analysis engine.

FIGS. 8A-D show an example operation dashboard with FIG. 8A showing a mixture of production and asset operational data, FIG. 8B showing the process of filtering recommendations based on selecting some of the operational data, FIG. 8C showing expanding the recommendation to triage it with the priority, and the opportunity value, and to assign it and raise a work order, and finally FIG. 8D showing the ability to move these into progress and monitor them to completion via a Kanban style board.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of this Disclosure.

It is noted that various connections between elements are discussed in the following detailed description. It is noted that these connections are general and, unless specified otherwise, may be direct or indirect, wired or wireless, and that the specification is not intended to be limiting in this respect.

### Chemical Plants and Catalysts

As a general introduction, chemical plants, petrochemical plants, and/or refineries may include one or more pieces of processing equipment that process one or more input chemicals to create one or more products. For example, catalytic dehydrogenation can be used to convert paraffins to the corresponding olefin, e.g., propane to propene, or butane to butene. All or portions of the plant may be configured to monitor operational data of the plant. For example, one or more sensors may be installed on the plant to monitor a flow rate through a pipe, an amount of vibration, a temperature, or the like. Other devices may be configured to monitor plant output (e.g., the quality and quantity of a product gas). Still other devices may be configured to monitor other plant operational data, such as the presence and actions taken by plant engineers, ambient conditions, the physical or computer security of computing devices at the plant, or the like.

References herein to a “plant” are to be understood to refer to any of various types of chemical and petrochemical manufacturing or refining facilities, or power applications such as power plants including wind or solar based power plants or generally any industrial automation facility. References herein to plant “operators” are to be understood to refer to and/or also include, without limitation, plant planners, managers, engineers, technicians, and other individuals interested in, overseeing, and/or running the daily operations at a plant.

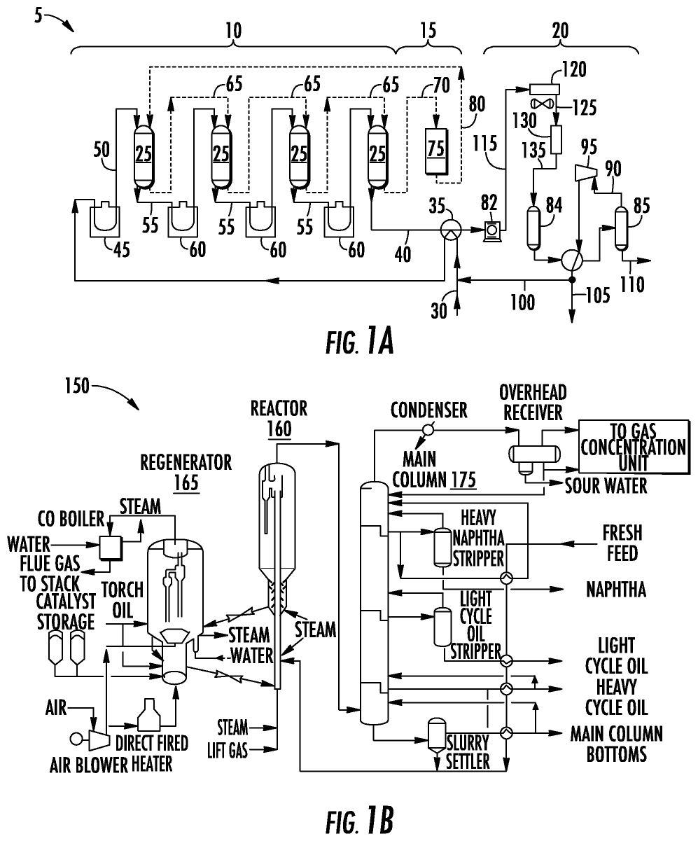

FIG. 1A shows an example system 5 for implementing a catalytic dehydrogenation process. The system 5 includes a reactor section 10, a catalyst regeneration section 15, and a product recovery section 20.

The reactor section 10 includes one or more reactors 25. A hydrocarbon feed 30 is sent to a heat exchanger 35 where it exchanges heat with a reactor effluent 40 to raise the feed temperature. The feed 30 is sent to a preheater 45 where it is heated to the desired inlet temperature. The preheated feed 50 is sent from the preheater 45 to the first reactor 25. Because the dehydrogenation reaction is endothermic, the temperature of the effluent 55 from the first reactor 25 is less than the temperature of the preheated feed 50. The effluent 55 is sent to interstage heaters 60 to raise the temperature of the effluent 55 to the desired inlet temperature for the next reactor 25.

After the last reactor, the reactor effluent 40 is sent to the heat exchanger 35, and heat is exchanged with the feed 30. The reactor effluent 40 is then sent to the product recovery section 20. The catalyst 65 moves through the series of reactors 25. When the catalyst 70 leaves the last reactor 25, it is sent to the catalyst regeneration section 15. The catalyst regeneration section 15 includes a regenerator 75 where coke on the catalyst is burned off and the catalyst may go through a reconditioning step. A regenerated catalyst 80 is sent back to the first reactor 25.

The reactor effluent 40 is compressed in the compressor or centrifugal compressor 82. The compressed effluent 115 is introduced to a cooler 120, for instance a heat exchanger. The cooler 120 lowers the temperature of the compressed effluent. The cooled effluent 125 (cooled product stream) is then introduced into a chloride remover 130, such as a chloride scavenging guard bed. The chloride remover 130 includes an adsorbent, which adsorbs chlorides from the cooled effluent 125 and provides a treated effluent 135. Treated effluent 135 is introduced to a drier 84.

The dried effluent is separated in separator 85. Gas 90 is expanded in expander 95 and separated into a recycle hydrogen stream 100 and a net separator gas stream 105. A liquid stream 110, which includes the olefin product and unconverted paraffin, is sent for further processing, where the desired olefin product is recovered and the unconverted paraffin is recycled to the dehydrogenation reactor 25.

FIG. 1B shows an example system 150 for implementing a fluid catalytic cracking (FCC) process that includes an FCC fluidized bed reactor 160 and a spent catalyst regenerator 165. Regenerated cracking catalyst entering the reactor, from the spent catalyst regenerator 165, is contacted with an FCC feed stream in a riser section at the bottom of the FCC reactor 160, to catalytically crack the FCC feed stream and provide a product gas stream, comprising cracked hydrocarbons having a reduced molecular weight, on average, relative to the average molecular weight of feed hydrocarbons in the FCC feed stream.

As shown in FIG. 1B, steam and lift gas are used as carrier gases that upwardly entrain the regenerated catalyst in the riser section, as it contacts the FCC feed. In this riser section, heat from the catalyst vaporizes the FCC feed stream, and contact between the catalyst and the FCC feed causes cracking of this feed to lower molecular weight hydrocarbons, as both the catalyst and feed are transferred up the riser and into the reactor vessel. A product gas stream comprising the cracked (e.g., lower molecular weight) hydrocarbons is separated from spent cracking catalyst at or near the top of the reactor vessel, preferably using internal solid/vapor separation equipment, such as cyclone separators. This product gas stream, essentially free of spent cracking catalyst, then exits the reactor vessel through a product outlet line for further transport to the downstream product recovery section.

The spent or coked catalyst, following its disengagement or separation from the product gas stream, requires regeneration for further use. This coked catalyst first falls into a dense bed stripping section of the FCC reactor 160, into which steam is injected, through a nozzle and distributor, to purge any residual hydrocarbon vapors that would be detrimental to the operation of the regenerator. After this purging or stripping operation, the coked catalyst is fed by gravity to the catalyst regenerator through a spent catalyst standpipe. FIG. 1B depicts a regenerator 165, which can also be referred to as a combustor. Regenerators may have various configurations. In the spent catalyst regenerator, a stream of oxygen-containing gas, such as air, is introduced to contact the coked catalyst, burn coke deposited thereon, and provide regenerated catalyst, having most or all of its initial coke content converted to combustion products, including CO₂, CO, and H₂O vapors that exit in a flue gas stream. The regenerator 165 operates with catalyst and the oxygen-containing gas (e.g., air) flowing upwardly together in a combustor riser that is located within the catalyst regenerator. At or near the top of the regenerator 165, following combustion of the catalyst coke, regenerated cracking catalyst is separated from the flue gas using internal solid/vapor separation equipment (e.g., cyclones) to promote efficient disengagement between the solid and vapor phases.

In the FCC recovery section, the product gas stream exiting the FCC reactor 160 is fed to a bottoms section of an FCC main fractionation column 175. Several product fractions may be separated on the basis of their relative volatilities and recovered from this main fractionation column 175. Representative product fractions include, for example, naphtha (or FCC gasoline), light cycle oil, and heavy cycle oil.

Other petrochemical processes produce desirable products, such as turbine fuel, diesel fuel and other products referred to as middle distillates, as well as lower boiling hydrocarbon liquids, such as naphtha and gasoline, by hydrocracking a hydrocarbon feedstock derived from crude oil or heavy fractions thereof. Feedstocks most often subjected to hydrocracking are the gas oils and heavy gas oils recovered from crude oil by distillation.

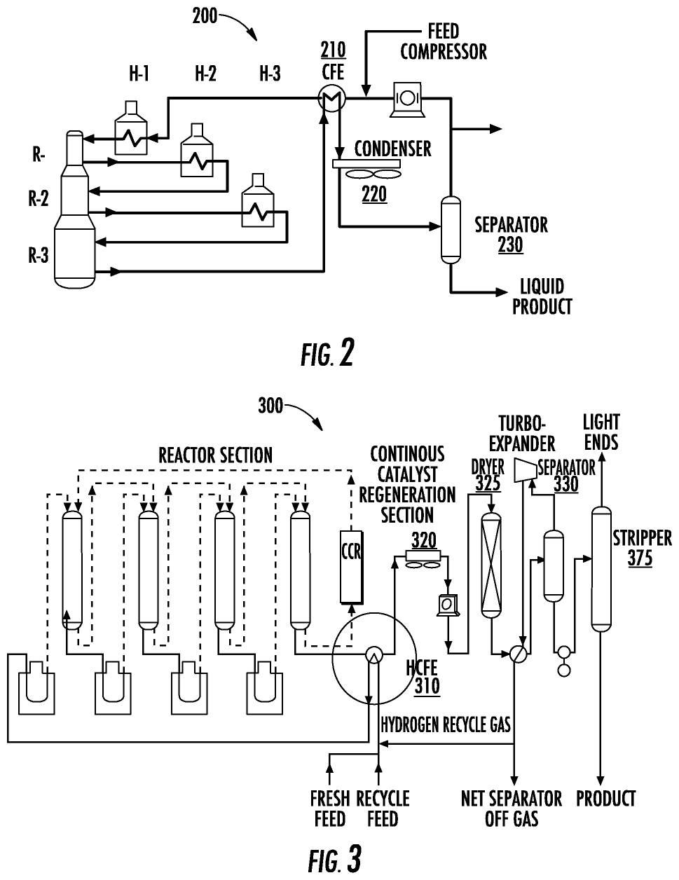

FIG. 2 shows an example system 200 for implementing a process of reforming with continuous catalyst regeneration (CCR) using a (vertically oriented) combined feed-effluent (CFE) exchanger 210. The cold stream, a combination of liquid feed (110.4° C.) with hydrogen rich recycle gas (e.g., light paraffins) (125.8° C.), is introduced into a CFE exchanger 210 where the feed is vaporized. For example, an entrance temperature: 96.9° C.; Exit temperature: 499.6° C. The feed/recycle exits the CFE exchanger 210 as a gas and goes through a series of heating and reaction steps. The resulting product effluent or hot stream is introduced into the CFE exchanger and is cooled down. (e.g., Entrance temperature: 527.9° C.; Exit temperature: 109.1° C.) The effluent exits the CFE exchanger 210 and is then cooled down further and condensed using an air cooler shown as condenser 220. The liquid product is separated by separator 230 from the gas stream containing hydrogen and light paraffins. Some of the gas stream is removed, for example as a product, and the rest of the stream is used as a recycle gas.

FIG. 3 shows an example system 300 for implementing an illustrative catalytic dehydrogenation process (e.g., an OLEFLEX process) with continuous catalyst regeneration (CCR) using a vertically-oriented hot combined feed-effluent (HCFE) exchanger 310. The cold stream, a combination of vapor feed with hydrogen rich recycle gas, is introduced into a HCFE exchanger and is heated. (e.g., Entrance temperature: 39.7° C.; Exit temperature: 533.7° C.) The feed/recycle exits the HCFE exchanger 310 as a gas and goes through a series of heating and reaction steps. The resulting product effluent or hot stream is introduced into the HCFE exchanger 310 and is cooled down. (e.g., Entrance temperature: 583.7° C.; Exit temperature: 142.3° C.) The effluent exits the HCFE exchanger and is then cooled down further using an air cooler shown as a condenser 320. The effluent then passes through a dryer 325, separators 330, and strippers 375. Hydrogen recycle gas is separated after the dryer 325 and returned to the feed stream.

### Analysis of Plant Operational Data

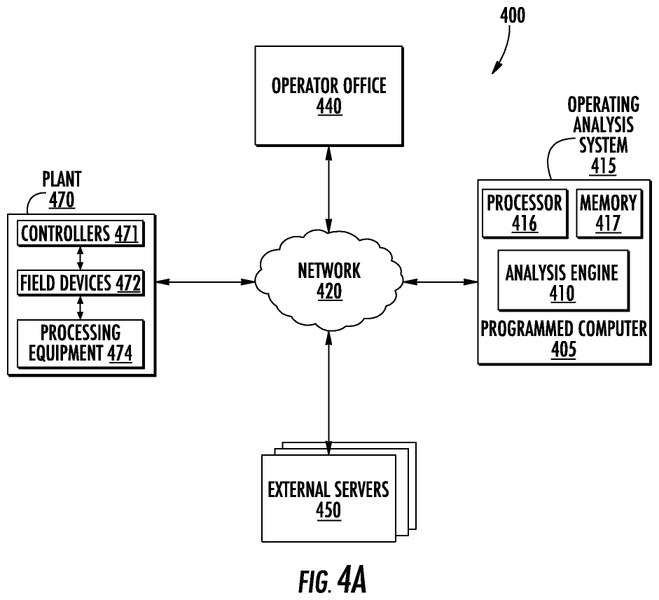

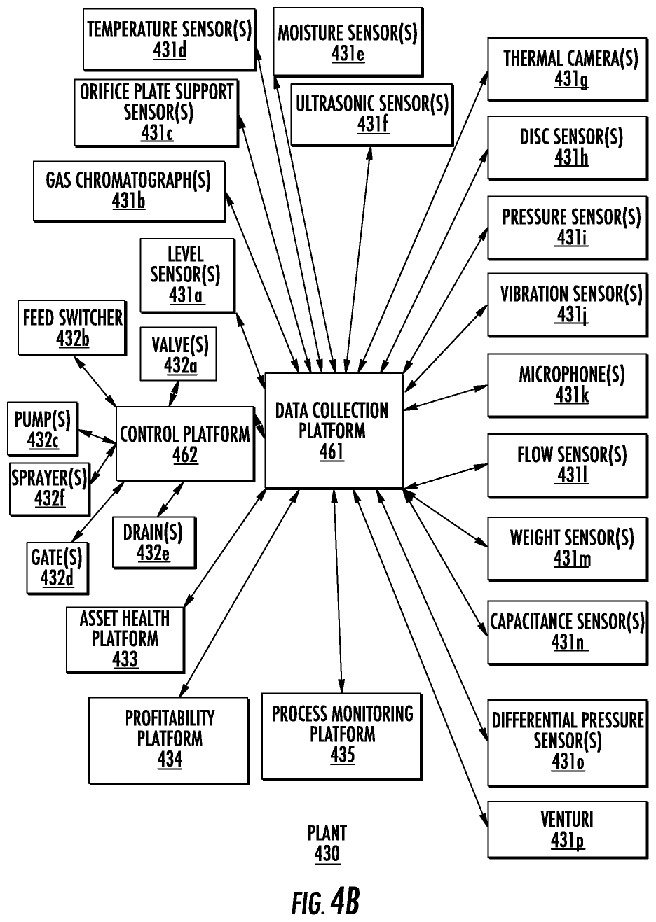

FIG. 4A shows an example network diagram of an operating analysis system 400 comprising a programmed computer 405 comprising a processor 416 having associated memory 417 configured to implement a disclosed analysis engine 410. The analysis engine 410 may be connected, via a network 420, such as an Ethernet network, to a plant 470 shown having process controllers 471 coupled to field devices 472 (e.g., sensors and actuators) coupled to processing equipment 474, an operator office 440, and external servers 450. The plant 470 is, for example, configured including controlled by one or more process controllers 471 and field devices 472 coupled to the processing equipment 474 to perform the catalytic dehydrogenation process of FIG. 1A, the fluid catalytic cracking process shown implemented in FIG. 1B, and/or the processes shown implemented in FIGS. 2 and 3. Moreover, as noted above the plant 470 can also comprise a power generation plant or power generation system, that may include a or a power storage system such as comprising at least one a battery. Though depicted as separate entities, the operating analysis system 415 implementing the analysis engine 410, the plant 470, the operator office 440, and the external servers 450 may all be in the same or in different locations.

The analysis engine 410 although shown implemented by a single program computer 405, the analysis engine may be implemented by two or more computing devices, such as one or more servers (e.g., a cloud computing platform) configured to receive operational data and determine one or more tasks. The analysis engine 410 may be configured to receive, from one or more sensors or platforms associated with the plant 470, operational data such as sensor measurements. The analysis engine 410 may be configured to process the received operational data, such as by performing error detecting routines, organizing the operational data, reconciling the operational data with a template or standard, and/or to store the received operational data.

Based on the operational data, the analysis engine 410 may be configured to determine one or more tasks. Though the analysis engine 410 is depicted as a single element in FIG. 4A, it may be a distributed network of computing devices located in a plurality of different locations. The analysis engine 410 may comprise instructions stored in memory and executed by one or more processors. For example, the analysis engine 410 may be implemented by an executable file. As another example, as shown in FIG. 4A, the analysis engine 410 may be implemented by a programmed computer 405 having one or more processors 416 and memory 417 storing instructions that, when executed by the one or more processors, performs the functions described herein.

The analysis engine 410 may process and/or analyze operational data. For example, the analysis engine 410 may be configured to execute code that compares operational data to threshold values and/or ranges. Machine-learning algorithms may be used to process and/or interpret operational data. For example, the analysis engine 410 may store and use historical operational data to teach a machine-learning algorithm acceptable ranges for operational data, and new operational data may be input into the machine-learning algorithm to determine if an undesirable plant condition exists. Manual review by plant “experts” may be performed to process and/or interpret operational data. For example, a certain range operational data (e.g., unexpectedly high temperature values) may involve manual review by an expert (e.g., a plant employee) using a computing device associated with the analysis engine 410.

The network 420 may be a public network, a private network, or a combination thereof that communicatively couples the analysis engine 410 to other devices. Communications between devices such as the computing devices of the plant 470 and the analysis engine 410, may be packetized or otherwise formatted in accordance with any appropriate communications protocol. For example, the network 420 may comprise a network configured to use Internet Protocol (IP).

As noted above, the plant 470 may be any of various types of chemical and petrochemical manufacturing or refining facilities. The plant 470 may be configured with one or more computing devices that monitor plant operational data and report such operational data to the analysis engine 410. The plant 470 may comprise sensors that report operational data to the analysis engine 410 via the network 420. The plant 470 may additionally or alternatively conduct tests (e.g., lab tests), which may be sent as operational data to the analysis engine 410. For example, operational data may relate to the pH or viscosity of liquids, the temperature of liquids, gasses, or solids (e.g., the temperature of a burner or an inlet valve), the molecular consistency of a substance, the color of a substance, the amount of power used (e.g., by a machine), or the like. Such reporting of operational data may occur on a periodic basis (e.g., every ten seconds, every hour, for each plant cycle).

The operator office 440 may be configured to, via one or more computing devices of the operator office 440, receive and/or send operational data to the analysis engine 410, configure the plant 470, and/or communicate with and configure the analysis engine 410. Operational data may originate from both the plant 470 and the operator office 440. For example, operational data such as one or more safety warnings and/or alerts may be transmitted from the operator office 440 to the analysis engine 410.

The external servers 450 may be configured to store operational data and/or information used to determine operational data. For example, the external servers 450 may store information relating to an average flow rate of a nozzle, which may be compared with an actual flow rate of a nozzle at the plant 470.

FIG. 4B shows an example of the plant 470 comprising a data collection platform 461 connected to a control platform 462, an asset health platform 433, a profitability platform 434, and a process monitoring platform 435. The data collection platform 461 is connected to sensors 431a-p. The control platform 462 is connected to controllable devices 432a-f. The sensors and controllable devices depicted in FIG. 4B are examples, any number or type of sensors and/or controllable devices may be implemented, whether or not connected to the data collection platform 461 or the control platform 462. Though the sensors and controllable devices depicted in FIG. 4B are shown as connected to the data collection platform 461 and the control platform 462, other platforms, such as the asset health platform 433, may receive data from the sensors and/or controllable devices.

The data collection platform 461 may be configured to collect operational data from one or more sensors and/or controllable devices and transmit that information, e.g., to the analysis engine 410. Such sensors may comprise, for example, level sensors 431a, gas chromatographs 431b, orifice plate support sensors 431c, temperature sensors 431d, moisture sensors 431e, ultrasonic sensors 431f, thermal cameras 431g which can also be a standard video camera, disc sensors 431h, pressure sensors 431i, vibration sensors 431j, microphones 431k, flow sensors 431l, weight sensors 431m, capacitance sensors 431n, differential pressure sensors 431o, and/or venturi 431p. The data collection platform may additionally or alternatively be communicatively coupled to the control platform 462 such that, for example, the data collection platform 461 may receive, from the control platform 462 and/or any of the controllable devices 432a-f, additional operational data corresponding to control of the plant 470. The controllable devices 432a-f may comprise, for example, valves 432a, feed switchers 432b, pumps 432c, gates 432d, drains 432e, and/or sprayers 432f.

The asset health platform 433 may be configured to collect information about the health of various plant assets, such as equipment. For example, the asset health platform 433 may monitor wear and tear on a periodically replaced component in a plant, such as a nozzle. The asset health platform 433 may be connected to one or more sensors on plant assets and/or may estimate asset health based on, for example, a depreciation schedule. The asset health platform 433 may be configured to receive, e.g., from the operator office 440, information about asset health. For example, an engineer may transmit, using a computing device coupled to a transmitter, results of an equipment inspection to the asset health platform 433.

The process monitoring platform 435 may be configured to, based on information received from one or more sensors, determine operational data corresponding to processes (e.g., the chemical reactions required to produce a product gas) in the plant. For example, the process monitoring platform 435 may be configured to determine, based on other operational data, whether a catalyst should be replaced. As another example, the process monitoring platform 435 may be configured to determine that the actual production of a plant is less than a projected production of the plant.

The profitability platform 434 may be configured to monitor plant variables corresponding to profit and loss. For example, the profitability platform may be configured to determine, based on the cost of plant operations and plant yield, an estimated profit per hour. The profit may be represented as, e.g., a currency value. The profit may be estimated based on, for example, a market value of a product gas.

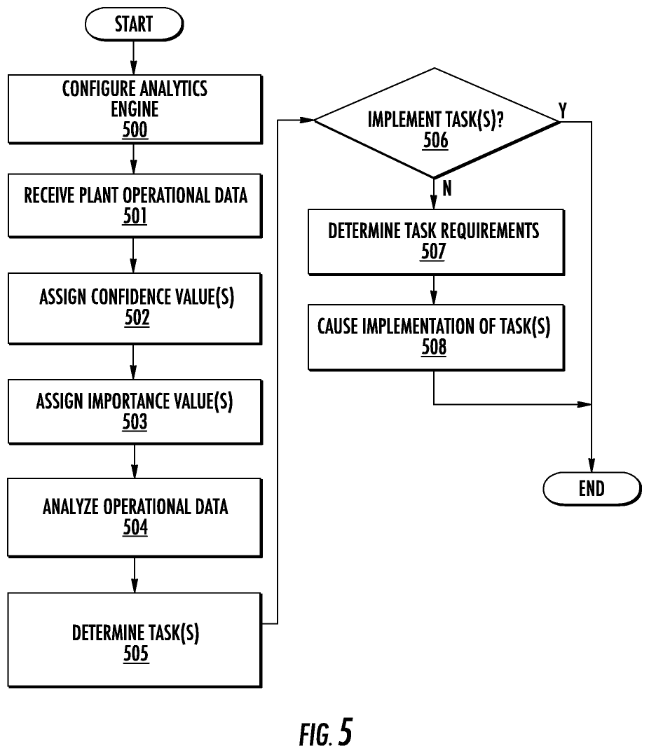

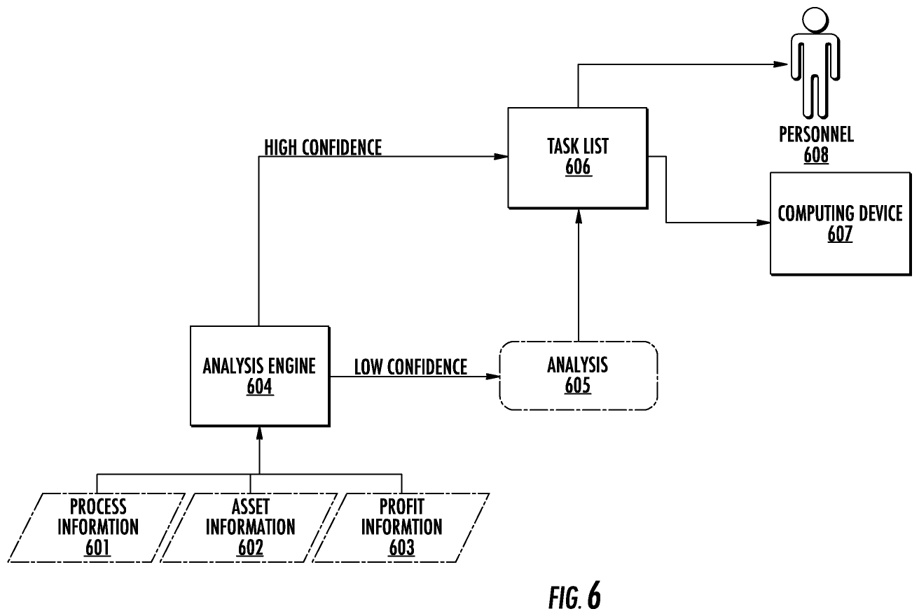

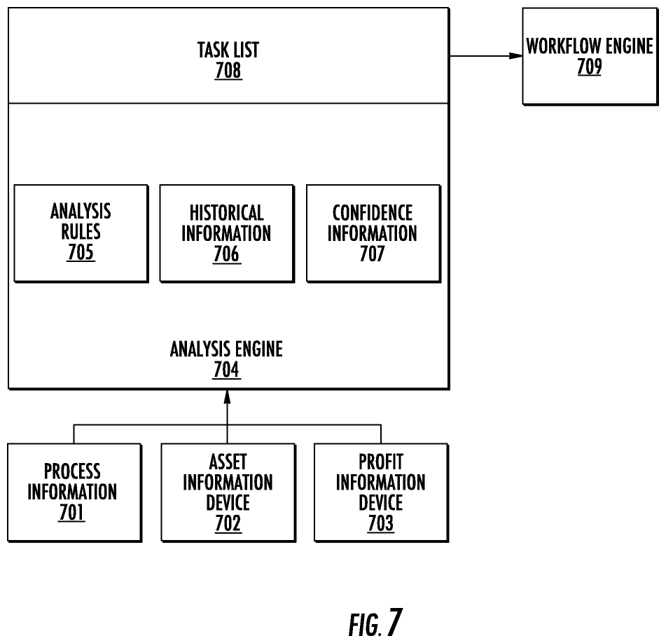

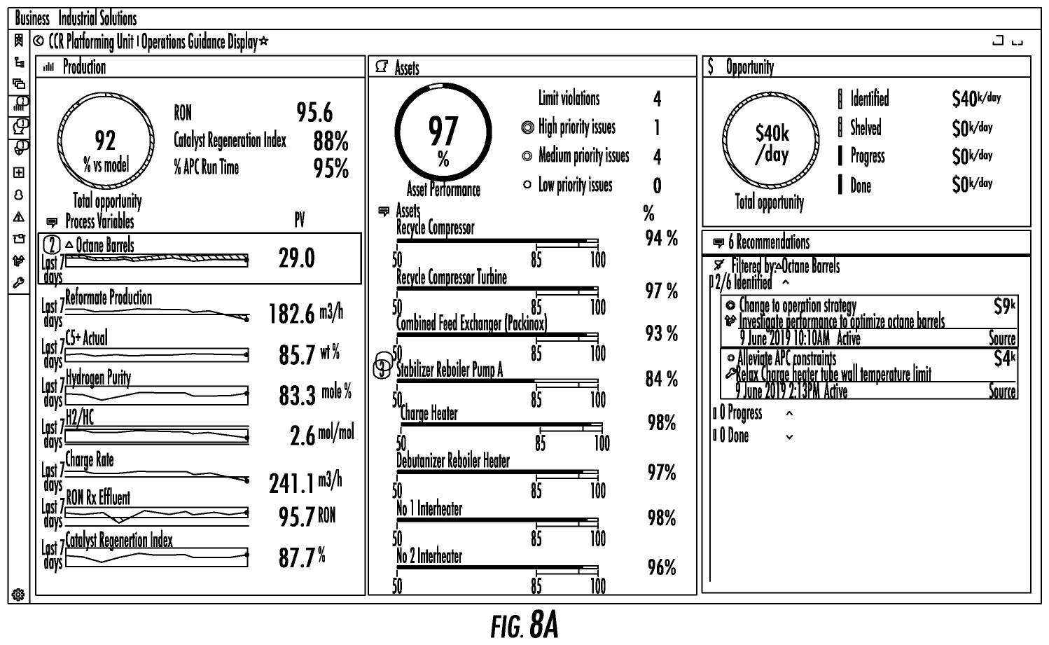

FIG. 5 shows a flow chart of a method that may be performed by a disclosed analysis engine. The method may be performed in real-time. In step 500, the analysis engine may be configured at one or more computing devices such as the operating analysis system 415 including the analysis engine 410 described above relative to FIG. 4A. The analysis engine may be configured to collect operational data, e.g., at a predetermined rate or at predetermined times from a plurality of different devices. The analysis engine may be configured with a threshold task importance, e.g., such that tasks assigned an importance value below the threshold are not acted upon. The analysis engine may be configured with baseline measurements or values, such as default temperatures for processes run at a particular plant. The analysis engine may be configured with a model of a plant such that the analysis engine may compare operational data received to model plant measurements. The model can comprise a fault tree, or a process model such as a digital twin. The analysis engine may be configured with one or more rules describing how tasks may be implemented.

In step 501, operational data is received from two or more devices in the plant. Operational data may come from any sources associated with the plant, such as the data collection platform 461, the control platform 462, the asset health platform 433, the profitability platform 434, and/or the process monitoring platform 435, and/or any of the sensors or devices depicted in FIG. 4B.

Operational data may comprise one or more alerts or warnings. An alert and/or warning may correspond to one or more problems corresponding to the plant. For example, an alert may indicate that a burner is no longer working. As another example, a warning may indicate that a burner is receiving an unexpectedly low quantity of fuel, and that the heat of the burner is dropping. Operational data may comprise warnings or alerts that are related and/or inconsistent. For example, one alert may indicate that the temperature of a burner is dropping, whereas another alert may indicate that the temperature of a substance heated by the burner is increasing. An alert and/or warning may correspond to a projected problem, e.g., a problem that has not yet occurred but that may occur in the future. For example, if a temperature of a substance is increasing rapidly, the present temperature of the substance may be tolerable, but a projected temperature of the substance in ten minutes may be undesirable.

Operational data may comprise information that may indicate symptoms of the one or more alerts or warnings. For example, an alert may indicate that a burner is no longer active, and operational data may indicate whether fuel is being sent to the burner. As another example, operational data may comprise information indicating a reliability or importance of an alert and/or warning. For example, operational data may comprise diagnostic information for a sensor, such that a reliability of sensor measurements may be determined.

Operational data may comprise plant production information. Plant production information may comprise any information relating to the production of a product by the plant, e.g., through chemical processes. Plant production information may comprise a warning and/or alert indicating that product yield has dropped, that a catalyst should be replaced, or the like. Plant production information may relate to chemical and/or mechanical aspects of plant production.

Operational data may comprise asset health and/or status. Asset health and/or status may comprise any information corresponding to a plant asset, such as an amount of wear, depreciation, whether or not the plant asset is in use, whether the plant asset is being used in an unintended manner, or the like. Asset health and/or status may comprise a warning and/or alert indicating that an asset is worn, broken, unreliable, or otherwise requiring maintenance. Asset health and/or status may comprise an indication of an operating status of a particular asset, such as a flow rate of a nozzle, a heat of a burner, or an amount of vibration of a particular asset. For example, asset health and/or status may comprise a warning and/or alert that an amount of vibration of a particular asset (e.g., a pipe) has exceeded a threshold.

Operational data may comprise profitability information. Profitability information may comprise any information relating to the profit of a plant, such as a dollar figure per hour, a ratio of costs versus the estimated value of product produced, or the like. For example, the profitability information may comprise an indication of the cost of plant operations, including raw materials, as compared to the market value of a product gas. As another example, the profitability information may comprise a warning and/or alert that profitability has dropped below a predetermined threshold.

Operational data may comprise workforce information. Workforce information may comprise any information relating to human effort at the plant, including the presence or absence of employees, current work efforts by employees, or the like. For example, the workforce information may comprise a warning and/or alert that an engineer is not monitoring a particular aspect of a plant. Such a warning and/or alert may be automatically determined, for example, by comparing a task list for the engineer with a list of tasks marked or determined as completed. If the system determines that a task that was supposed to have been performed has not been completed (e.g., by determining that the task was not marked as completed, or by determining based on one or more measurements that the task was not completed), the system may determine that the engineer is not monitoring the particular aspect of the plant.

Operational data may comprise automation system and/or control information. Automation system and/or control information may comprise any information about systems used to control and/or automate all or portions of a plant. For example, automation system and/or control information may comprise a warning and/or alert that a control system is no longer functioning or has input values which exceed a predetermined threshold.

Operational data may comprise safety information. Safety information may comprise any information associated with the safe operation of a plant. For example, the safety information may comprise a warning and/or alert that occupational safety standards have been exceeded, that atmospheric conditions of a plant are unsafe for human presence (e.g., because a quantity of a particular substance (e.g., carbon monoxide in the air) exceeds a threshold), or the like.

Operational data may comprise cybersecurity information. Cybersecurity information may comprise information associated with the security of devices, such as computing devices, associated with the plant. For example, cybersecurity information may comprise a warning and/or alert that cyber protection software on a device is out of date or insecure. The system may determine a version of the software on the device, connect to a server to determine a most current version of the cyber protection software on the device, and compare the most current version to the version of the software on the device to determine whether the cyber protection software on the device is out of date.

In step 502, confidence values may be assigned to the operational data received. The confidence values may be derived from one or more inputs such as the accuracy of the sensor, the quality of communications with the sensor, and whether or not the measurement value provided by the sensor is within the operating limits of the sensor. For example, a particular sensor may only be reliable within a certain temperature range, and outside of that temperature range it may be less accurate, or the system may have poor communication signal quality with the sensor in which case the readings may be out of date (not current). In the case of a communications signal, the signal quality may dynamically change the confidence reading, in the other cases it can be based on the configuration of the sensor and its tolerances. The confidence values may be expressed as percentages, generally from 0% to 100%.

All or portions of the operational data may be unreliable. For example, a measurement received from one sensor may be known to be accurate ±5%, whereas another sensor may be known to be accurate ±15%, such that the former sensor is more reliable than the second sensor. As another example, one warning or alert may be particularized and provide supporting information, whereas another warning or alert may be more vague, suggesting that the former warning or alert is more reliable than the latter. Confidence values reflecting a reliability of all or portions of the operational data may be assigned. For example, one warning or alert may be determined to be 50% reliable, whereas another may be determined to be 90% reliable. Confidence values may be based on whether the operational data is within an expected range of values. For example, a temperature measurement that is outside of predicted values may be assigned a lower confidence value than a temperature measurement within predicted values.

In step 503, importance values may be assigned to the operational data received. The importance values are generally pre-determined based on a thorough risk analysis of the process and the control system when the plant is being designed and the alarms/alerts are being configured. Certain portions of the operational data may be more important to the operation of a plant than other portions. For example, a warning that an operating system has not been updated on a plant engineer's laptop may be categorized as less important than a fire occurring in the plant. Importance values reflecting an importance, e.g., to plant operators, may be assigned to all or portions of the operational data. For example, the aforementioned plant fire may be determined to have an importance of ten out of ten, whereas the aforementioned operating system issue may be determined to have an importance of three out of ten. The importance values may be expressed as percentages.

In step 504, the operational data may be analyzed. Operational data may be analyzed to determine correlations between different portions of the operational data. For example, reduced flow rate of fuel to a burner, dropping burner temperature, and the malfunction of a fuel tank may be correlated as all related to the malfunction of the fuel tank. As another example, undesirable vibrations in pipes and an imbalance in a motor located nearby those pipes may be correlated, as the motor may be vibrating the pipes. As yet another example, a malfunction in a computing device in the plant may be correlated with a determination that software on the computing device has not been upgraded in a certain period of time (e.g., years).

Analysis of operational data may comprise running a model of the plant. All or portions of the operational data may be used to model the plant, e.g., using a software simulation, and simulated plant values may be compared to actual operational data values. For example, portions of operational data assigned high confidence values may be used in a software model, and simulated values from the software model may be compared to portions of the operational data that are assigned low confidence values. The model of the plant can implement steps including analyzing the operational data to provide the assigning of the numerical confidence values and to provide the assigning of the numerical importance values to the operational data. As described above, the model can comprise a fault tree or a process model such as a digital twin.

In step 505, based on the analysis of the operational data, one or more tasks may be determined. A task may correspond to one or more actions performed with respect to the plant. A task may be modifying one or more plant parameters (e.g., a burner temperature) of a plant, adding, modifying, or removing plant assets, or the like. For example, a task may be to replace a burner, alter the fuel flow to a burner, or to clean a burner. As another example, a task may be to add or remove a reactor. The task may comprise taking all or portions of the plant offline and/or shutting down the plant.

Tasks may be determined to remediate one or more warnings and/or alerts in the operational data. Tasks may be prioritized. For example, tasks that address multiple warnings and/or alerts may be selected instead of or in addition to tasks that address only one warning and/or alert. Tasks may be assigned importance and/or confidence values based on the importance and/or confidence values assigned to all or portions of the operational data. Not all possible tasks need be determined: for example, only tasks associated with all or portions of operational data having a sufficiently high importance and/or confidence value may be determined.

In step 506, it is determined whether one or more of the tasks should be implemented. All or some of the tasks determined might not be associated with sufficiently important operational data or might not be supported by operational data having sufficiently high confidence values (e.g., confidence value over a threshold). Some tasks may be more or less important than other tasks. For example, a task to upgrade an operating system of a computing device may be determined, but the task may not be as important as a fire in the plant, such that all resources should be devoted to resolving the fire, rather than upgrading the operating system. If it is determined that one or more tasks should be implemented, the flow chart proceeds to step 507. Otherwise, the method ends.

In step 507, if one or more tasks are determined to be needed to be implemented, task requirements may be determined. Task requirements may be requirements associated with one or more actions associated with a task. For example, the action of adjusting the flow rate of fuel to a burner may require human interaction (e.g., that a specific engineer walk to and turn a knob), or may require one or more instructions to other devices (e.g., that a particular computing device receive instructions specifying a new flow rate for the burner). One or more actions may comprise receiving authorization and/or approval, e.g., from a supervisor. While one task may require involvement by a first set of individuals (e.g., engineers physically at a plant), another task may require involvement by a different set of individuals (e.g., administrators not physically at the plant). A task may be automatically resolved by one or more devices (e.g., automatically adjusting the knob, automatically adjusting the flow rate to the burner). Thus, one or more tasks may be assigned for a computing system or platform to complete. A task need not solve a problem, but may be a task associated with diagnosing a problem detected.

Step 508 comprises implementation of the one or more tasks. Causing implementation of a task may comprise displaying, e.g., on one or more computing devices, an indication of the task and necessary actions to complete the task. For example, the task, an importance and/or confidence level associated with the task, and actions required to complete the task may be shown in a graphical dashboard on a display of a computing device. Such a display may prompt specific individuals to perform one or more actions. For example, one display for an engineer may display one action associated with the task, and a different display for a different engineer may display a different action associated with the same task. The display may include a prompt for permission to automatically take an action associated with the task. Causing implementation of a task may comprise transmitting, e.g., to a computing device in the plant, instructions which cause one or more actions associated with the task to be performed. For example, a computing device managing an air blower may be instructed to speed up or slow down the blower.

Implementation of one or more actions corresponding to the task may be tracked, such that completion of the task may be monitored. For example, one or more tasks may be stored, and a completion status of one or more actions associated with the task may be tracked. Completion of a task may be determined after receiving, from a user device (e.g., a mobile device, an augmented-reality headset) of an engineer assigned to the task, confirmation of completion of the task. Alternatively, or additionally, one or more operational data values may be used to determine the completion of the task. For example, if the task was to increase a fuel flow to the burner, and the flow to the burner has increased by more than a threshold amount, then the system may determine that the task was completed.

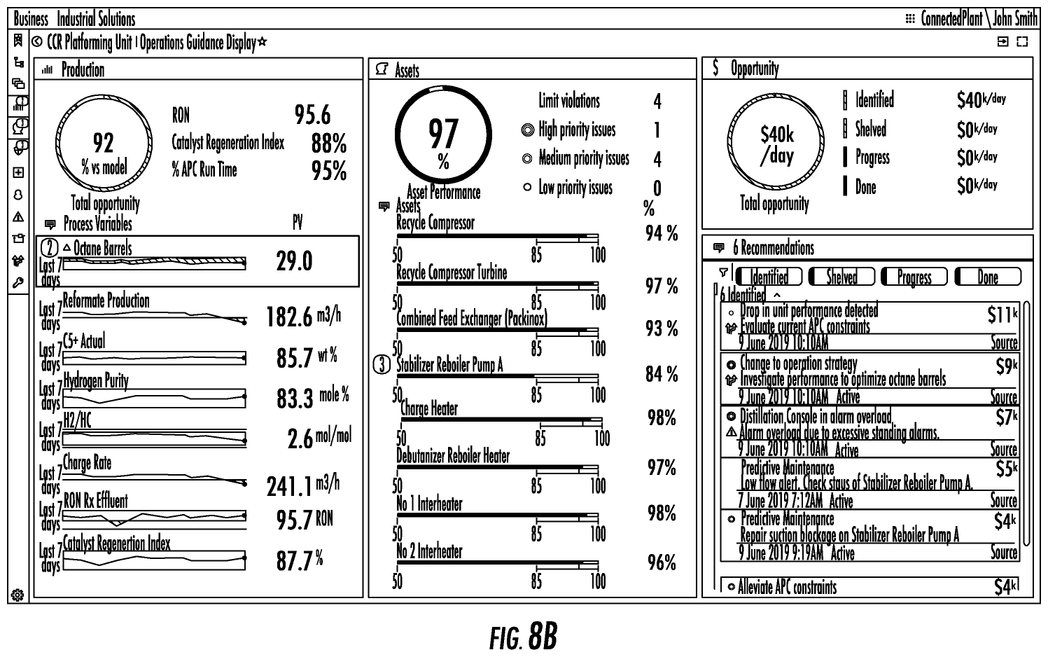

FIG. 6 is an illustrative example of a data flow using a disclosed analysis engine. Process information 601, asset information 602, and profit information 603 may be information received from devices and/or sensors, such as those depicted in FIG. 4B. For example, the process information 601 may relate to a catalyst, the asset information 602 may relate to the operating status of a burner, and the profit information 603 may relate to a profitability of a plant. Such information is received by an analysis engine 604, which may be the same or similar as the analysis engine 410. If the information is of low confidence (e.g., if the information has a low confidence value), further analysis may be performed, as represented by block 605, in order to determine one or more tasks (if any), and such tasks may be added to a task list 606.

The analysis represented by block 605 may comprise determining a cost of one or more warnings, alerts, and/or alarms, determining a confidence level of one or more warnings, alerts, and/or tasks, ordering (e.g., by priority) one or more warnings, alerts, and/or tasks, or the like. If the information is of high confidence (e.g., if the information is associated with a high confidence value), tasks may be determined and added to the task list 606. The task list 606 may be published or otherwise made available, e.g., as displayed via a computing device. The task list 606 may be different for different individuals and/or devices. For example, one or more tasks and/or one or more actions corresponding to one or more tasks may be transmitted to the computing device 607, whereas the same or different one or more tasks and/or one or more actions corresponding to one or more tasks may be transmitted to personnel 608.

FIG. 7 is a diagram showing an illustrative example of an example analysis engine 704. A process information device 701, an asset information device 702, and a profit information device 703 may be the same or similar as the devices depicted in FIG. 4B. All such devices may transmit information to the analysis engine 704, which may be the same or similar as the analysis engine 410 described above relative to FIG. 4A. For example, the process information device 701 may transmit information to the analysis engine 704 relating to a catalyst, the asset information 602 may transmit information to the analysis engine 704 relating to the operating status of a burner, and the profit information 603 may transmit information to the analysis engine 704 relating to a profitability of a plant.

The analysis engine 704 may be configured with analysis rules 705, historical information 706, confidence information 707, and a task list 708. The analysis rules 705 may comprise one or more rules for analyzing operational data, such as an importance of certain portions of operational data as compared to other portions of operational data. The historical information 706 may comprise historical operational data, which may be compared to current operational data to determine trends. The confidence information 707 may comprise information on how reliable operational data is, such as indications of which sensors (e.g., the sensors depicted in FIG. 4B) may be relied upon and which sensors may be unreliable. The analysis engine 704 may fill the task list 708 with tasks based on analysis of operational data. One or more tasks from the task list 708 and/or one or more actions associated with the one or more tasks may be transmitted to a workflow engine 709, which may be configured to cause implementation of the tasks. For example, the workflow engine 709 may be configured to take a task (e.g., that a burner needs to be hotter), determine relevant actors involved in the task (e.g., determine a computing device having control over fuel flow to the burner), and cause the task to be implemented (e.g., transmit a command to the computing device to increase fuel flow).

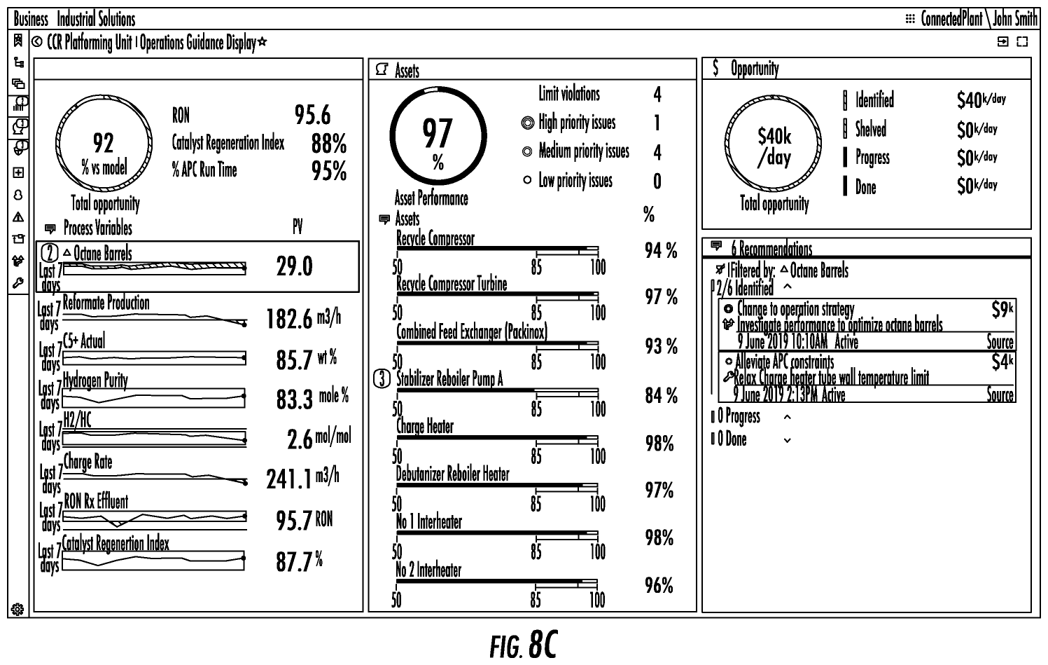

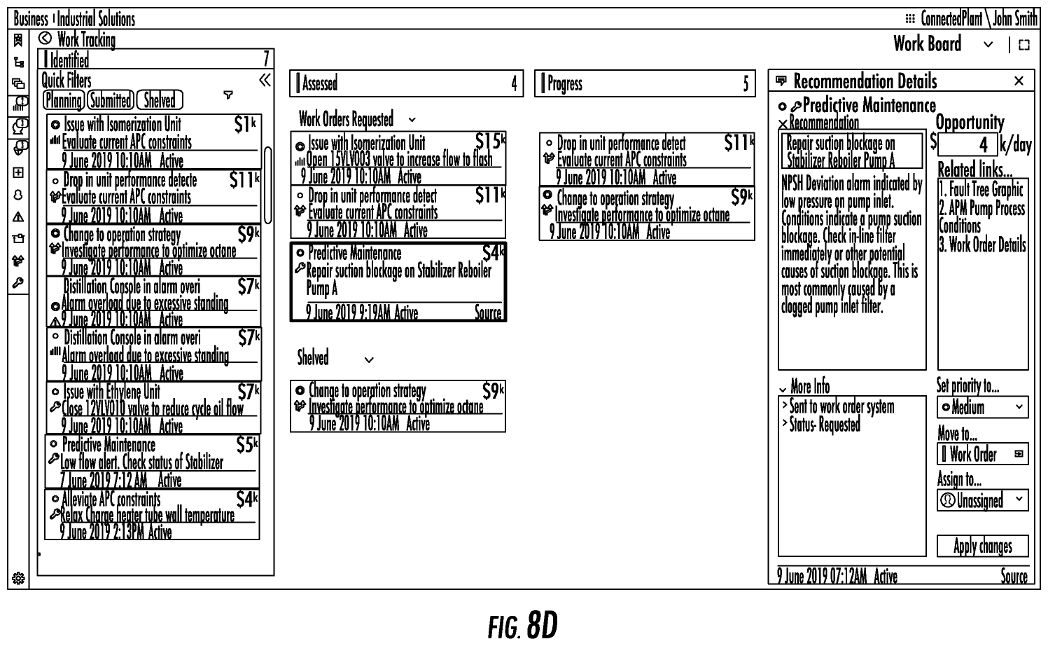

FIGS. 8A-D show an example operation dashboard with FIG. 8A showing a mixture of production and asset operational data, then FIG. 8B showing the process of filtering recommendations based on selecting some of the operational data. FIG. 8C then shows expanding the recommendation to triage it with the priority, and the opportunity value, and to assign it and raise a work order, and finally FIG. 8D shows the ability to move these into progress and monitor them to completion via a Kanban style board that visually depicts work at various stages of a process using cards to represent work items and columns to represent each stage of the process.

Aspects of this Disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps illustrated in the illustrative figures may be performed in other than the recited order, and one or more depicted steps may be optional in accordance with aspects of the Disclosure.

1. A method comprising:
a computing device comprising a processor including an associated memory receiving operational data associated with a plant that has processing equipment configured and controlled to run a process involving at least one tangible material or a power application from two or more devices in the plant, the operational data comprising one or more alerts associated with one or more problems that have occurred at the plant;
the computing device:
assigning at least one numerical confidence value relating to a reliability to each of the operational data;
assigning at least one numerical importance value relating to importance to an operation of the plant to each of the operational data;
analyzing to determine correlations between different portions of the operational data;
determining, based on the confidence values and the importance values, at least one task associated with resolving the problem;
determining an action associated with the task, and
transmitting to another computing device an indication relating to the action.

2. The method of claim 1, wherein the indication comprises a message that includes instructions usable to perform the action.

3. The method of claim 1, wherein the method is performed by the computing device in real-time.

4. The method of claim 1, wherein the numerical confidence values and the numerical importance values are both expressed as percentages.

5. The method of claim 1, wherein the operational data comprises at least one of information regarding a profit or loss of the plant, the processing equipment, workforce performance, automation system performance, safety system performance, and cybersecurity performance.

6. The method of claim 1, wherein the computing device further implements running at least one model of the plant to implement steps including analyzing the operational data to provide the assigning of the numerical confidence values, and to provide the assigning of the numerical importance values to each of the operational data.

7. The method of claim 6, wherein the model includes a fault tree or a process model.

8. Method of claim 7, wherein the model includes the process model, and wherein the process model comprises a digital twin.

9. The method of claim 1, wherein the computing device utilizes a machine-learning algorithm to implement a portion of the method.

10. A system, comprising:
a computing device comprising a processor including an associated memory for realizing an analysis engine that is configured for:
receiving operational data associated with a plant that has processing equipment configured and controlled to run a process involving at least one tangible material or a power application from two or more devices in the plant, the operational data comprising one or more alerts associated with one or more problems that have occurred at the plant;
assigning at least one numerical confidence value relating to a reliability to each of the operational data;
assigning at least one numerical importance value relating to importance to an operation of the plant to each of the operational data;
analyzing the operational data to determine correlations between different portions of the operational data;
determining, based on the confidence values and the importance values at least one task associated with resolving the problem,
determining an action associated with the task, and
transmitting to another computing device, an indication relating to the action.

11. The system of claim 10, wherein the indication comprises a message that includes instructions to perform the action.

12. The system of claim 10, wherein the computing device executes in real-time.

13. The system of claim 10, wherein the numerical confidence values and the numerical importance values are both expressed as percentages.

14. The system of claim 10, wherein the operational data comprises at least one of information regarding a profit or loss of the plant, the processing equipment, workforce performance, automation system performance, safety system performance, and cybersecurity performance.

15. The system of claim 10, wherein the computing device further implements running at least one model of the plant to implement steps including analyzing the operational data to provide the assigning of the numerical confidence values and to provide the assigning of the numerical importance values to each of the operational data.

16. The system of claim 15, wherein the model includes a fault tree or a process model.

17. The system of claim 16, wherein the model includes the process model, and wherein the process model comprises a digital twin.

18. The system of claim 10, wherein the computing device utilizes a machine-learning algorithm.
